(19) United States
(12) Patent Application Publication
(10) Pub. No.: US 2015/0122964 A1
(43) Pub. Date: May 7, 2015

(54) MEDIUM-SUPPORTING DEVICE AND MEDIUM-PROCESSING APPARATUS

(71) Applicant: MIMAKI ENGINEERING CO., LTD., NAGANO (JP)

(72) Inventor: Ichirou Sunohara, Nagano (JP)

(21) Appl. No.: 14/407,470

(22) PCT Filed: Jul. 22, 2013
(86) PCT No.: PCT/JP2013/069833

§ 371 Date: Dec. 12, 2014

(30) Foreign Application Priority Data
Jul. 23, 2012 (JP) 2012-162309

(51) Int. Cl. B41J 11/00; B41J 11/06; F16M 13/00; B65H 1/04; F16M 11/00

(52) U.S. Cl. CPC B41J 11/0085; B65H 1/04; F16M 11/00; F16M 13/00; B41J 11/06; F16M 2200/00
USPC 248/363; 248/694

(57) ABSTRACT

Provided is a medium-supporting device that is lightweight and can be formed at a low cost and with high precision even when a medium-supporting surface has a large area, and a medium-processing apparatus equipped with the medium-supporting device. As a solution, a medium-supporting device (10) according to the present invention includes multiple tubular members (25) arranged in parallel at a given interval such that openings (25a) thereof are directed in the same direction, and a first plate-like member (11) joined to the tubular members (25) so as to block the openings (25a).

### TECHNICAL FIELD

The present invention relates, generally, to a medium-supporting device and a medium-processing apparatus and, more particularly, to a medium-supporting device for supporting a medium when processing such as printing or cutting is performed on the medium, and a medium-processing apparatus equipped with the medium-supporting device.

### BACKGROUND ART

Such a medium-processing apparatus may include, for instance, an ink jet printing apparatus for performing printing on a medium or a cutting apparatus for performing cutting on a medium.

To be specific, an ink jet printing apparatus is conventionally known which can print a desired image on a sheet-shaped medium supported on a platen (medium-supporting device) by combining an operation of causing a printing unit mounted with an ink jet head discharging ink to move rightward and leftward relative to the medium and an operation of sending the medium in forward and backward directions. On the other hand, a cutting apparatus is also known which can carry out desired cutting on a sheet-shaped medium supported on a platen by combining an operation of causing a cutting unit mounted with a cutting head having a cutter blade to move rightward and leftward relative to the medium and an operation of sending the medium in forward and backward directions. For example, stickers of various patterns and shapes can be made by printing a desired image on a medium in which a backing sheet and adhesive paper are joined using the ink jet printing apparatus and cutting the medium along an outline of the desired image using the cutting apparatus. Further, a printing and cutting apparatus configured to additionally mount a cutting unit on an ink jet printing apparatus and to allow performing printing and cutting in a single apparatus is also developed (see Patent Document 1).

In the medium-processing apparatus exemplified above, when the medium is processed (for instance, printed and cut), high-precision positioning is required for a printing position or a cutting position. Especially, it is important to form a platen (hereinafter, referred to simply as a “platen”) with high precision, which acts as a medium-supporting device for supporting a medium when the medium is processed, so as to be empty of distortion.

For example, in the case of a flatbed-type ink jet printing apparatus, the conventional platen includes a lower panel and an upper panel joined to the lower panel via an intermediate structure. Further, there is also a configuration in which numerous adsorption holes are provided for the upper panel and an air suction means for sucking air in a closed space formed between the lower panel and the upper panel is provided. According to such a configuration, when the air in the closed space is sucked by the air suction means, the air is sucked from the adsorption holes of the upper panel. As such, it is possible to obtain an effect of adsorbing the medium to the upper panel.

Here, as an example of the intermediate structure constituting the platen, a honeycomb structure is conventionally used (see FIG. 11). As an example, a honeycomb structure formed by laminating thin plate-like members formed of an aluminum alloy or a material such as a carbon graphite sheet to which a polymeric film is joined while intermittently bonding the plate-like members and stretching the laminate in a laminating direction is known (see Patent Document 2).

### PRIOR ART DOCUMENTS

### Patent Documents

Patent Document 1: Japanese Patent Laid-open Publication No. 2003-266377

Patent Document 2: Japanese Patent No. 4244627

### SUMMARY OF THE INVENTION

### Problems to be Solved by the Invention

However, the intermediate structure of the platen exemplified above is the honeycomb structure formed by a process of cutting (or forming) thin plates formed of the aluminum alloy or the like in a predetermined shape and a process of laminating and stretching the thin plates while intermittently bonding the thin plates. As such, there is a problem of costing a lot in order to precisely carry out these processes to obtain the high-precision honeycomb structure.

Further, in the case of the platen in which the numerous adsorption holes are provided for the upper panel, the adsorption holes and the intermediate structure (honeycomb structure) sometimes interfere with each other, and the adsorption holes are blocked by the honeycomb structure. Thereby, there is a problem that a medium adsorption force is biased.

The present invention has been made keeping in mind the above problems, and an object of the present invention is to provide a medium-supporting device that is lightweight and can be formed at a low cost and with high precision even when a medium-supporting surface has a large area, and a medium-processing apparatus equipped with the medium-supporting device.

### Solutions to the Problems

The problems are addressed by the solution as disclosed below as one embodiment.

A medium-supporting device of the disclosure includes multiple tubular members arranged in parallel at given intervals such that openings thereof are directed in the same direction, and a first plate-like member joined to the tubular members so as to block the openings. According to this, as intermediate structures joined to the first plate-like member, the multiple tubular members can be used in place of a conventional honeycomb structure. Accordingly, a process of cutting (or forming) thin plates formed of, for instance, an aluminum alloy in a predetermined shape and a process of stacking and stretching the thin plates while intermittently adhering the thin plates, both of which were required to form the honeycomb structure, are not required. As such, it is possible to form the intermediate structures at a very low cost, and to make a platen at a low cost. Further, only by forming each tubular member (especially, axial dimensions) within a given precision range, improvement in precision of the platen can be easily achieved. Furthermore, when the tubular members are formed using, for instance, a resin material, the platen can be made lightweight.

Further, in the present invention, it is preferred that the medium-supporting device further includes a second plate-like member provided opposite to the first plate-like member, in which the first plate-like member has first hole portions passing through outside and inside thereof, and the multiple tubular members are arranged in a closed space formed between the first plate-like member and the second plate-like member. The closed space is formed by sealing an outer circumference of the platen using a resin material such as rubber. According to this, as the closed space is under a negative pressure using an air suction means, an effect of sucking air in a direction directed into the closed space at the first hole portions is obtained, and a medium can be adsorbed to and supported on the first plate-like member.

Further, in the present invention, it is preferred that the first plate-like member has the first hole portions passing through the outside and inside thereof at positions at which the first plate-like member blocks the openings of the tubular members, and each of the tubular members has a second hole portion, which passes through interior and exterior thereof, in a lateral surface thereof. According to this, as a through-hole (second hole portion) is provided in the lateral surface of the tubular member, when the closed space is under a negative pressure, the interior of the tubular member can also be under a negative pressure. Accordingly, an adsorption hole (first hole portion) can also be arranged at a position corresponding to the opening of the tubular member at the first plate-like member. As such, a degree of freedom of the arrangement position of the adsorption hole can be improved.

Further, in the present invention, it is preferred that the medium-supporting device further includes a spacer configured to arrange the multiple tubular members in parallel at regular intervals. According to this, a minimum number of multiple tubular members can be arranged in parallel to the extent to which a deformation volume is allowed at the first plate-like member. Accordingly, the intermediate structures and thus the platen can be made at a low cost. Further, as the spacer is provided, the parallel arrangement work of the tubular members is made easy, and thus the platen can be manufactured with ease and at a low cost. Furthermore, when the tubular members are formed using, for instance, a resin material, outer circumferential portions thereof are predicted to be what is called thick (that is, that the difference between the inner diameter and the outer diameter is great) compared to when they are formed using a metal material. However, in the case of such a thick structure, a solid region is increased compared to the case of a thin structure. As such, there is a problem that a possibility of the solid region blocking the adsorption holes is increased. However, as described above, if the minimum number of multiple tubular members can be arranged in parallel, it is easy to avoid blocking the adsorption holes, and it is possible to prevent unbalance of a medium adsorption force caused by the blockage of the adsorption holes and to increase the medium processing precision.

Further, in the present invention, it is preferred that the second hole portions of the tubular members are provided at positions at which the second hole portions do not interfere with a lateral surface of the spacer. If the second hole portions of the tubular members interfere with the lateral surface of the spacer, the interiors of the tubular members cannot be under a negative pressure even when the closed space is under a negative pressure, and thus there occurs a problem that no adsorption force is generated at the adsorption holes located inside the openings of the tubular members. In contrast, according to the above configuration, since the second hole portions and the lateral surface of the spacer do not interfere with each other, such a problem can be prevented. Further, when the parallel arrangement work of the tubular members is done, it is unnecessary to adjust the directions of the tubular members such that the second hole portions are not blocked by the lateral surface of the spacer. As such, the parallel arrangement work is made easy, and the platen can be manufactured with ease and at a low cost.

A medium-processing apparatus of the disclosure includes the medium-supporting device, and an air suction means for sucking air in the closed space. According to this, by applying the medium-supporting device that is lightweight and can be formed at a low cost and with high precision, the medium can be processed with high precision and the medium-processing apparatus can be realized with lightweight at a low cost. Particularly, it is preferably applied to a large flatbed type apparatus.

### Effects of the Invention

According to the medium-supporting device of the disclosure, the medium-supporting device is lightweight, and can be formed at low cost and with high precision even when a medium-supporting surface has a large area. Further, by applying the medium-supporting device to the medium-processing apparatus, the medium can be processed with high precision.

### BRIEF DESCRIPTION OF THE DRAWINGS

FIG. 1 is a schematic view illustrating an example of a medium-supporting device and a medium-processing apparatus according to an embodiment of the present invention.

FIG. 2 is a schematic view illustrating an example of the medium-supporting device and the medium-processing apparatus according to the embodiment of the present invention.

FIGS. 3A and 3B are schematic views illustrating an example of a rightward/leftward movement mechanism in the medium-processing apparatus according to the embodiment of the present invention.

FIGS. 4A and 4B are schematic views illustrating an example of an ink jet head in the medium-processing apparatus according to the embodiment of the present invention.

FIG. 5 is a schematic view illustrating an example of the medium-supporting device according to the embodiment of the present invention.

FIG. 6 is an explanatory view illustrating an example of arrangement positions of tubular members in the medium-supporting device according to the embodiment of the present invention.

FIG. 7 is a schematic view illustrating an example of a spacer in the medium-supporting device according to the embodiment of the present invention.

FIG. 8 is an explanatory view illustrating a modification of the arrangement positions of the tubular members in the medium-supporting device according to the embodiment of the present invention.

FIG. 9 is a schematic view illustrating a modification of the spacer in the medium-supporting device according to the embodiment of the present invention.

FIG. 10 is an explanatory view illustrating an example of arrangement positions of first hole portions in an upper panel of the medium-supporting device according to the embodiment of the present invention.

FIG. 11 is a schematic view illustrating an example of a medium-supporting device according to a prior art embodiment.

### EMBODIMENTS OF THE INVENTION

Hereinafter, an embodiment of the present invention will be described in detail with reference to the drawings. Here, as a medium-processing apparatus having a built-in medium-supporting device according to the present embodiment, a flatbed type printing and cutting apparatus will be described as an example. In the whole drawings for describing the embodiment, members having the same function are given the same reference signs, and repetitive description thereof may be omitted.

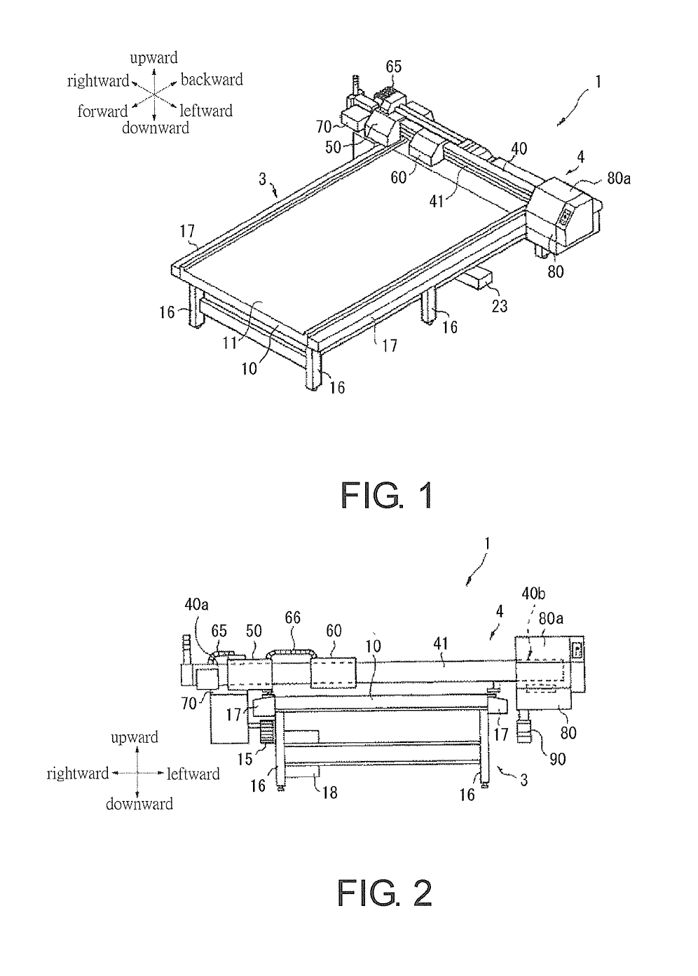

FIG. 1 is a schematic perspective view illustrating a printing and cutting apparatus 1 equipped with a medium-supporting device (platen 10) according to the present embodiment. Further, FIG. 2 is a schematic rear view illustrating the printing and cutting apparatus 1. For convenience of description, forward/backward, rightward/leftward, and upward/downward directions of the printing and cutting apparatus 1 are indicated by arrow directions in FIGS. 1 and 2. Further, a forward/backward direction of the paper in FIG. 2 is defined as the forward/backward direction of the printing and cutting apparatus 1.

The printing and cutting apparatus 1 according to the present embodiment is equipped with an ink jet head 60 and a cutting head 50, and is an apparatus that carries out an operation, which is selected from an operation of performing only printing, an operation of performing only cutting, and an operation of performing both the printing and the cutting for dealing with a printed image of the printing, on a sheet-like medium supported by the platen 10 depending on the purpose.

The printing and cutting apparatus 1 is configured such that a second subassembly 4 is assembled above a first subassembly 3 as an entire configuration.

Here, the first subassembly 3 is configured such that forward/backward movement mechanisms 17 and 17 extending in the forward/backward direction are provided on the right and left sides of the platen 10 supporting the medium that is a processing target. A power supply and control machinery 18 are arranged on a lower side of the platen 10.

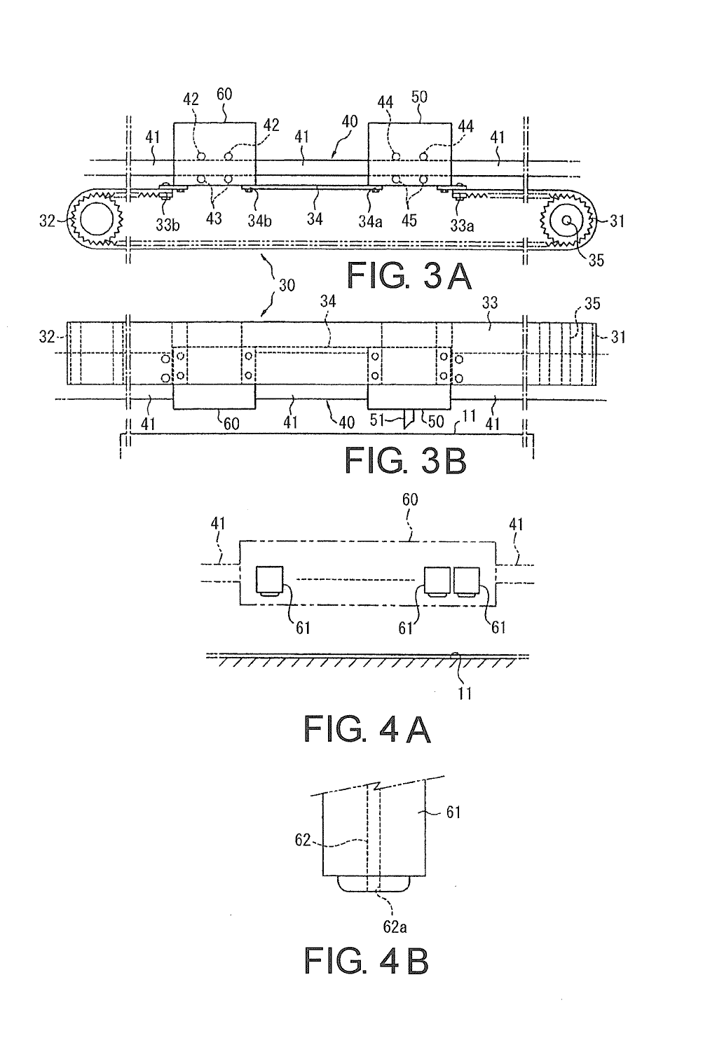

Further, the second subassembly 4 is configured such that the ink jet head 60 and the cutting head 50 are mounted so as to be movable rightward and leftward along a long guide bar member 40 extending in the rightward/leftward direction and a rightward/leftward movement mechanism 30 (see FIGS. 3A and 3B) displacing the ink jet head 60 and the cutting head 50 in the rightward/leftward direction is provided. Further, an ink supply device 70 and a maintenance unit 80 are configured to be mounted on right and left ends of the guide bar member 40.

First, a configuration of the platen 10 will be described.

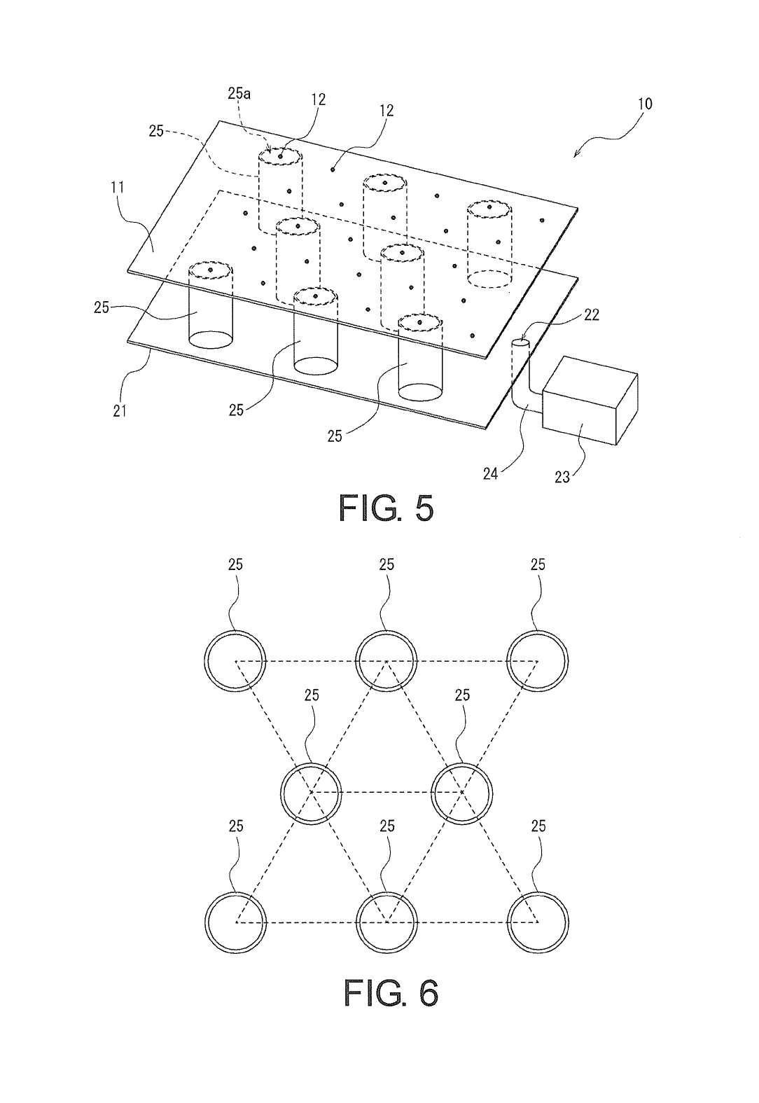

As illustrated in FIGS. 1 and 5, the platen 10 has multiple legs 16 that are supported and fixed to a floor, a first plate-like member (hereinafter referred to as an “upper panel”) 11 on which the medium that is the processing target is placed and which supports the medium, and a second plate-like member (hereinafter referred to as a “lower panel”) 21 that supports the upper panel 11 via intermediate structures 25. Here, the upper panel 11 is arranged above the floor at a given height. Further, the upper panel 11 is provided with multiple hole portions (hereinafter referred to as “first hole portions”) 12 passing through the inside and outside thereof (in a thickness direction). According to this configuration, air is sucked from an outer surface to an inner surface of the first hole portions 12 using an air suction means 23. Thereby, the medium can be adsorbed to and supported on the upper panel 11 (which will be described below for details).

Here, the guide bar member 40 is arranged above the platen 10, but it is formed to have a longer rightward/leftward length than the platen 10. As such, right and left ends 40a and 40b of the guide bar member 40 structurally protrude rightward and leftward with respect to the platen 10.

Next, a configuration of the rightward/leftward movement mechanism 30 will be described.

As illustrated in FIGS. 3A and 3B (wherein FIG. 3A is a schematic plan view, and FIG. 3B is a schematic rear view), the rightward/leftward movement mechanism 30 provided for the second subassembly 4 includes a driving sprocket 31, a driven sprocket 32, a toothed belt 33 stretched around the driving sprocket 31 and the driven sprocket 32, and a connecting member 34 linking the cutting head 50 and the ink jet head 60. Here, the toothed belt 33 is configured such that one end 33a thereof is attached to the ink jet head 60 and the other end 33b thereof is attached to the cutting head 50. Further, the connecting member 34 is configured such that one end 34a thereof is attached to the ink jet head 60 and the other end 34b thereof is attached to the cutting head 50. Further, the cutting head 50 and the ink jet head 60 may be configured to be integrally attached to the toothed belt 33 without using the connecting member 34.

Further, the driving sprocket 31 and the driven sprocket 32 are rotatably supported at the right and left ends of the platen 10, respectively. The driving sprocket 31 is connected to a driving motor (not shown) via a shaft 35, and is configured to be able to be rotated by a rotary driving force of the driving motor.

Further, two pairs of front and rear guide rollers 42 and 43, both of which use the upward/downward direction as an axis of rotation, are attached to the interior of the cutting head 50 at an interval in the rightward/leftward direction. The two pairs of front and rear guide rollers 42 and 43 are rotatably attached with a guide rail 41 sandwiched therebetween in the forward/backward direction, wherein the guide rail 41 is arranged at the guide bar member 40 so as to horizontally extend in the rightward/leftward direction. With this configuration, the cutting head 50 can move along the guide rail 41 in the rightward/leftward direction.

Further, two pairs of front and rear guide rollers 44 and 45, both of which use the upward/downward direction as an axis of rotation, are attached to the interior of the ink jet head 60 at an interval in the rightward/leftward direction. The two pairs of front and rear guide rollers 44 and 45 are attached with the guide rail 41 sandwiched therebetween in the forward/backward direction. With this configuration, the ink jet head 60 can move along the guide rail 41 in the rightward/leftward direction.

According to the rightward/leftward movement mechanism 30 configured in this way, as the driving motor is driven, the driving sprocket 31 is rotated and driven via the shaft 35, and the toothed belt 33 moves in the rightward/leftward direction. Both of the cutting head 50 and the ink jet head 60 attached to the toothed belt 33 function to move in the rightward/leftward direction while being guided by the guide rail 41 with an interval between these heads held by the connecting member 34 linking both of the heads.

Subsequently, a configuration of the cutting head 50 will be described.

The cutting head 50 according to the present embodiment is configured such that a cutter 51, which protrudes downward to make a cut into the surface of the medium that is the processing target (makes a cut into an adhesive portion of the surface with an adhesive applied in a given shape without making a cut into a backing sheet of the medium), is attached at a lower portion thereof so as to be movable up and down (see FIG. 3B). The cut making operation caused by the cutter 51 may become an operation of performing separation by cutting the backing sheet of the medium together in addition to the operation of making a cut into only the surface of the medium as described above.

Next, a configuration of the ink jet head 60 will be described.

The ink jet head 60 according to the present embodiment has multiple ink jet nozzles (hereinafter referred to as “nozzles”) 61 lined up in the rightward/leftward direction (see FIG. 4A), or is formed such that each nozzle 61 has an ink passage 62 with a jet 62a opened downward (see FIG. 4B). Here, FIG. 4A is a schematic view illustrating a configuration example of the multiple nozzles 61, and FIG. 4B is a schematic view illustrating a configuration example of the surroundings of a tip of each nozzle 61.

Further, a right end 40a of the guide bar member 40 is provided with an ink supply device 70 for supplying ink to the ink passage 62, and a controller (not shown) for performing movement control of the cutting head 50 and the ink jet head 60 and jet control of the ink jet head 60 (see FIG. 2).

On the other hand, a left end 40b of the guide bar member 40 is provided with a housing 80a covering the left end 40b and a maintenance unit 80 inside the housing 80a. The maintenance unit 80 is a mechanism for restoring the jet 62a to a condition in which the ink is normally ejected from the jet 62a by sucking the ink remaining inside the ink passage 62 or removing ink refuse or waste attached to the surroundings of the jet 62a. Further, a waste ink tank 90 is provided below the maintenance unit 80, and can accumulate the ink treated at the maintenance unit 80.

Subsequently, a configuration such as wiring for drive and control will be described.

In the present embodiment, as illustrated in FIG. 2, a first flexible cable guide 15 (for instance, a Cable Bear (registered trademark)) connecting a right lower portion of the platen 10 and the ink supply device 70 is provided. An electric wire for supplying power or control signals for controlling driving of devices at the side of the second subassembly 4 from a power supply and a control machinery 18 arranged on the platen 10 is arranged in the first flexible cable guide 15. According to this configuration, the power or the control signals can be supplied from the side of the first subassembly 3 to the side of the second subassembly 4 while allowing forward/backward movement of the guide bar member 40 relative to the platen 10.

Further, a second flexible cable guide 65 connecting the right end 40a of the guide bar member 40 and the cutting head 50 is provided. An electric wire for supplying power or control signals for controlling upward/downward movement of the cutter 51 of the cutting head 50 or upward/downward movement of the nozzles 61 of the ink jet head 60 from the control machinery 18, or a tube for supplying the ink from ink supply device 70 to the ink jet head 60 via the cutting head 50 is arranged in the second flexible cable guide 65. According to this configuration, the power and the control signals or the ink can be supplied from the side of the ink supply device 70 to the side of the cutting head 50.

Furthermore, a third flexible cable guide 66 connecting the cutting head 50 and the ink jet head 60 is provided. An electric wire for supplying power or control signals for controlling upward/downward movement of the nozzles 61 of the ink jet head 60 from the control machinery 18, or a tube for supplying the ink from ink supply device 70 to the ink jet head 60 is arranged in the third flexible cable guide 66. According to this configuration, the power and the control signals or the ink can be supplied from the side of the cutting head 50 to the side of the ink jet head 60.

With the configuration described above, the printing and cutting apparatus 1 according to the present embodiment can carry out an operation, which is selected from an operation of performing only printing, an operation of performing only cutting, and an operation of performing both the printing and the cutting for dealing with a printed image of the printing, on the medium depending on the purpose.

For example, as for the operation of performing both the printing and the cutting, first, the guide bar member 40 moves back and forth relative to platen 10, and the ink jet head 60 moves back and forth and right and left while causing the jet 62a to face the surface of the medium held on the platen 10. During the movement, the ink is ejected from the jet 62a, and desired letters and patterns are printed on the top of the medium. Subsequently, the guide bar member 40 moves back and forth relative to the platen 10, and the cutting head 50 moves back and forth and right and left while causing the blade edge of the cutter 51 provided at the lower portion of the cutting head 50 to face the surface of the medium held on the platen 10. Thereby, the surface of the medium is cut at a desired position of the medium. In this way, the printing and cutting apparatus 1 is very efficient in that the printing and cutting of a desired image can be continuously performed without removing the medium from the platen 10 every time.

Here, a configuration of the platen 10 characteristic of the present embodiment will be described in detail.

As illustrated in the schematic perspective view of FIG. 5, the platen 10 includes a lower panel 21 and an upper panel 11 joined to the lower panel 21 via intermediate structures 25. In the present embodiment, the upper panel 11 and the lower panel 21 are arranged opposite to each other so as to be parallel, and are fixed by screwing. Here, both the upper panel 11 and the lower panel 21 are configured using a tabular member (also including a member that a sheet-like material is spread in a tabular shape). The tabular member may employ any of a monolayer structure and a laminated structure. As an example, in the case of a large flatbed type apparatus, the upper panel 11 and the lower panel 21 are formed with dimensions of about 3000 mm long by 1600 mm wide.

The lower panel 21 supports the upper panel 11 via the intermediate structures 25, and thus is held on the floor at a given height. As an example, the lower panel 21 is formed of aluminum or an aluminum alloy in the shape of a rectangular flat plate having a given thickness.

On the other hand, the upper panel 11 places the medium that is the processing target, and supports the medium. As an example, the lower panel 21 is fon led of aluminum or an aluminum alloy in the shape of a rectangular flat plate having a given thickness. The upper panel 11 according to the present embodiment produces medium adsorption to be described below, and thus is provided with multiple hole portions (first hole portions) 12 passing through the front and back thereof (in a thickness direction).

Here, multiple tubular members are used as the intermediate structures 25. The present embodiment has a configuration in which the multiple tubular members 25 are arranged in parallel on the lower panel 21 at given intervals such that openings 25a thereof are directed in the same direction, and the upper panel 11 are joined to the tubular members so as to block the openings. As an example of the forming method, first, the lower panel 21 is laid, and the multiple tubular members 25 are fixed by a thermoplastic binding material. Then, the thermoplastic binding material is also applied to upper ends of the tubular members 25, and covers the tubular members 25 with the upper panel 11. Finally, a pressing force is given to the top of the upper panel 11 by a roller having a built-in heater in order to secure precision of a medium processing surface.

The tubular members 25 are not limited to a cylinder, and may be a tube whose cross section is a hexagonal shape, an octagonal shape, or a tetragonal shape. As an example, the tubular members 25 are formed using a resin material such as vinyl chloride, but they are not limited to such a material. A metal material such as an aluminum alloy may be used. In this way, the use of a lightweight material such as a resin material can make the platen 10 lightweight.

According to the above configuration, in place of a conventional honeycomb structure, the multiple tubular members 25 can be used as the intermediate structures. Accordingly, a process of cutting (or forming) thin plates formed of, for instance, an aluminum alloy in a predetermined shape and a process of stacking and stretching the thin plates while intermittently adhering the thin plates, both of which were required to form the honeycomb structure, are not required. As such, it is possible to form the intermediate structures at a very low cost, and to make the platen 10 inexpensive. Further, each tubular member 25 (especially, axial dimensions) is only formed within a given precision range, and thereby improvement in precision of the platen 10 can be easily achieved. Further, as the tubular members 25 are foinied using a resin material such as vinyl chloride, the platen 10 can be made lightweight. When the tubular members 25 are manufactured by resin molding, they may be molded one by one or in a group at once.

Here, in the present embodiment, spacers 13 for arranging the multiple tubular members 25 in parallel at regular intervals are provided. In this case, the interval is preferably set such that a deformation volume generated at the upper panel 11 falls within a given allowance range when the upper panel 11 is placed on the tubular members 25.

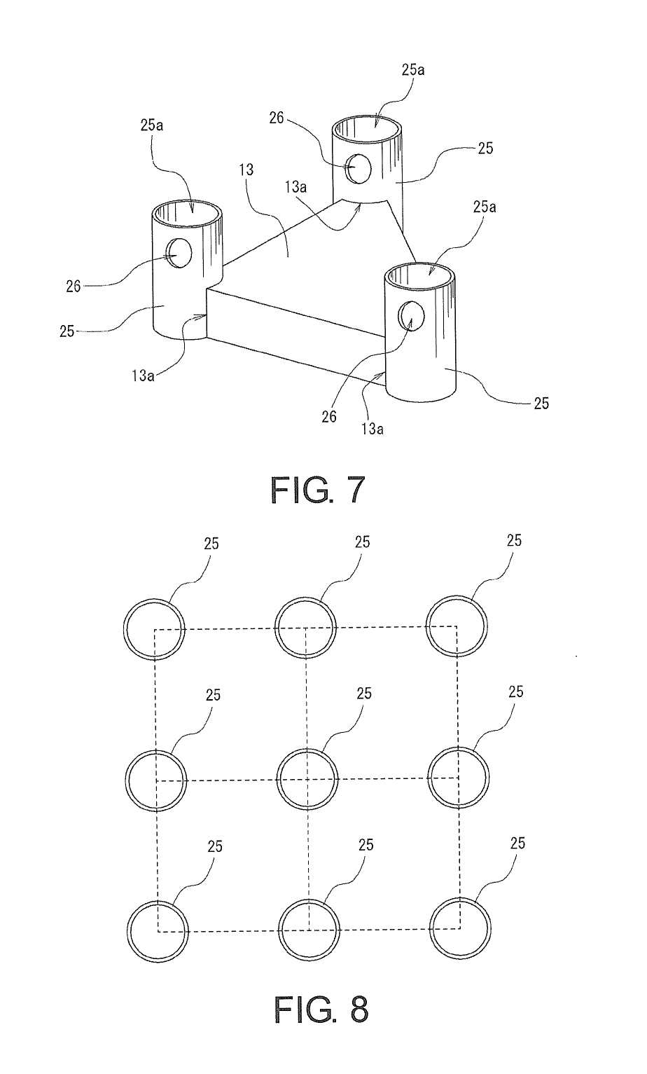

As an example of the parallel arrangement structure of the tubular members 25, as illustrated in FIG. 6, the multiple tubular members 25 may be configured to be arranged in parallel at regular intervals such that the central positions thereof are disposed in a regular triangle. According to such disposition, a required number of the tubular members 25 can be minimized. In this case, as illustrated in the schematic perspective view of FIG. 7, the spacer 13 may have a shape capable of prescribing only positions at which the tubular members 25 are disposed. To be more specific, as illustrated in FIG. 7, a periphery of the spacer 13 is provided with cutout portions 13a formed in the shape of a cutout prescribing the positions at which the tubular members 25 are disposed. A shape of each cutout portion 13a is not particularly limited, and is formed by a curved surface or multiple planes. The spacer 13 is formed using, for instance, a material such as a resin or a styrene foam.

In place of the cutout portion 13a formed in the cutout shape, a part or whole of the cutout portion may be formed as a fitting groove portion (not shown) formed in a groove shape.

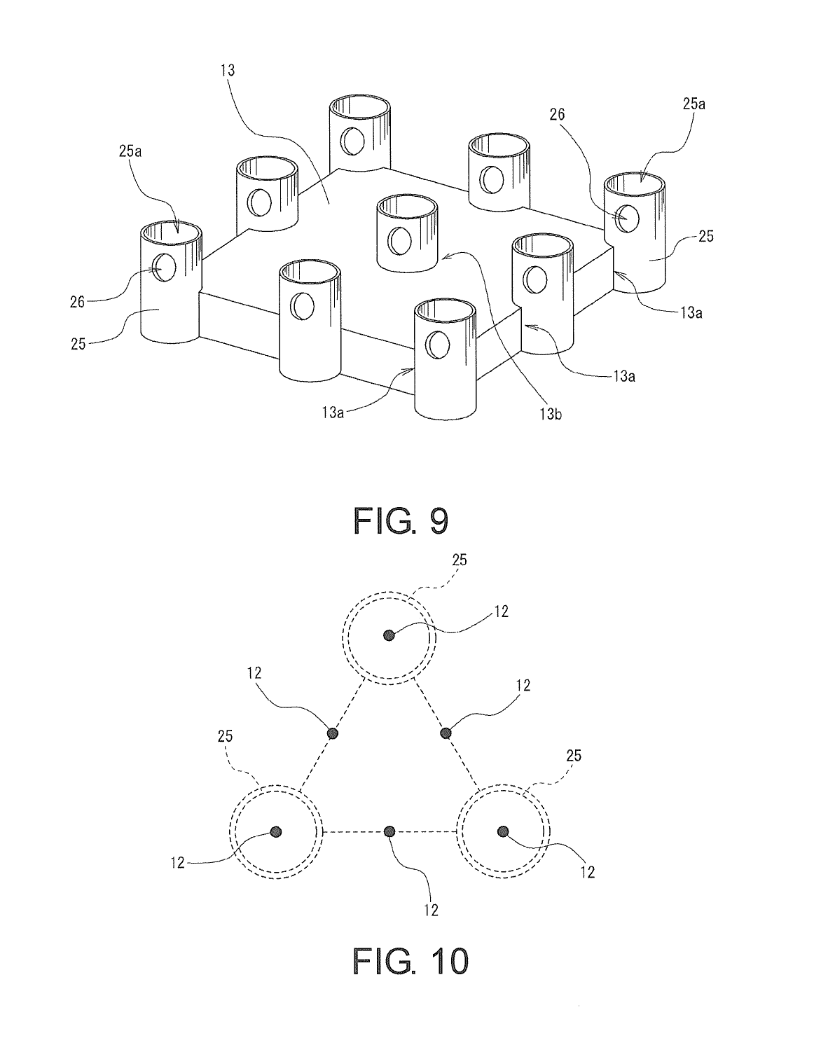

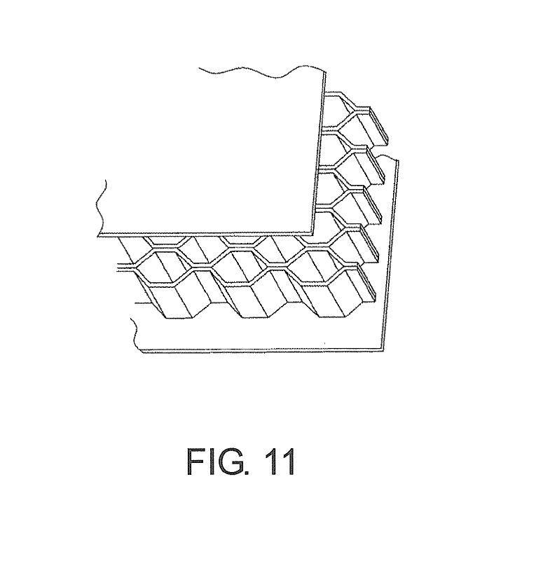

Further, as a modification of the parallel arrangement structure of the tubular members 25, as illustrated in FIG. 8, the multiple tubular members 25 may be configured to be arranged in parallel at regular intervals such that the central positions thereof becomes a quadrilateral shape (for instance, a square shape). In this case, the spacer 13 may have a shape as illustrated in the schematic perspective view of FIG. 9. To be more specific, as illustrated in FIG. 9, a periphery of the spacer 13 is provided with cutout portions 13a formed in the shape of a cutout prescribing the positions at which the tubular members 25 are disposed. Further, the middle of the spacer 13 is provided with a fitting groove portion 13b formed in the shape of a groove into which the tubular member 25 can be impacted. For example, the fitting groove portion 13b is formed such that an inner diameter thereof has the same dimension as an outer diameter of the tubular member 25.

In place of the cutout portion 13a formed in the cutout shape, a part or whole of the cutout portion may be formed as a fitting groove portion (not shown) formed in a groove shape.

According to the above configuration, the minimum number of multiple tubular members 25 can be arranged in parallel. Accordingly, the intermediate structures and thus the platen 10 can be made at a low cost. Further, by providing the spacer(s) 13, the parallel arrangement work of the tubular members 25 is made easy, and thus the platen 10 can be manufactured with ease and at a low cost. Furthermore, when each tubular member 25 is formed using, for instance, a resin material, an outer circumferential portion thereof is predicted to be what is called thick (that is, that a difference between the inner diameter and the outer diameter is great) compared to when it is formed using a metal material. However, in the case of such a thick structure, a solid region is increased compared to the case of a thin structure, and thus a possibility of the corresponding region blocking the adsorption hole 12 of the upper panel 11 is increased. However, if the minimum number of tubular members 25 can be arranged in parallel, it is easy to avoid a problem of blocking the adsorption holes 12, and it is possible to prevent unbalance of a medium adsorption force caused by the blockage of the adsorption holes 12 and to increase medium processing precision.

Further, in the present embodiment, the upper panel 11 and the lower panel 21 are configured such that a space therebetween becomes a closed space that can be sealed. Such a closed space is formed by sealing an outer circumference of the platen 10, that is, outer circumferences of the upper panel 11 and the lower panel 21 joined via the tubular members 25 using a resin material (not shown) such as rubber.

Further, the air suction means 23 is provided to suck air in the closed space. As the air suction means 23, for example, a vacuum pump or an air compressor may be used. The present embodiment is configured such that a pump hole 22 is formed in the middle of the lower panel 21 and passes through the lower panel 21, and a suction tube 24 connected to a vacuum pump 23 is coupled to the pump hole 22 (see FIG. 5), but it is not limited thereto.

According to the above configuration, as the closed space is under a negative pressure using the air suction means 23, an effect of sucking air in a direction directed from the outer surface to the inner surface at the first hole portions 12 of the upper panel 11, that is, in a direction directed from the outside to the interior of the closed space, is obtained, and the medium can be adsorbed to and supported on the upper panel 11.

Further, as a configuration characteristic of the present embodiment, as illustrated in FIG. 10, the first hole portions 12 of the upper panel 11 are arranged at positions at which the opening 25a of the tubular members 25 are blocked at the upper panel 11.

Furthermore, each tubular member 25 is provided with a second hole portion 26 in a lateral surface thereof which passes through the interior and exterior thereof.

According to the above configuration, as the through-hole (second hole portion) 26 is provided in the lateral surface of the tubular member 25, when the closed space is under a negative pressure, the interior of the tubular member 25 can also be under a negative pressure. Accordingly, the adsorption hole (first hole portion) 12 capable of sucking the air can also be arranged at a position corresponding to the opening 25a of the tubular member 25 at the upper panel 11. As such, a degree of freedom of the arrangement position of the adsorption hole 12 can be improved.

Here, the second hole portion 26 of the tubular member 25 is preferably provided at a position at which the second hole portion 26 does not interfere with a lateral surface of the spacer 13 (see FIG. 7). If the second hole portion 26 of the tubular member 25 interferes with the lateral surface of the spacer 13, the interior of the tubular member 25 cannot be under a negative pressure even when the closed space is under a negative pressure, and thus there occurs a problem that no adsorption force is generated at the adsorption hole 12 located inside the opening 25a of the tubular member 25. In contrast, according to the above configuration, since the second hole portion 26 and the lateral surface of the spacer 13 do not interfere with each other, such a problem can be solved. Further, in doing the parallel arrangement work of the tubular members 25, it is unnecessary to adjust directions of the tubular members 25 such that the second hole portions 26 are not blocked by the lateral surfaces of the spacers 13. As such, the parallel arrangement work is made easy, and the platen 10 can be manufactured with ease and at a low cost.

As a modification, the upper panel 11 may be configured such that the adsorption hole (first hole portion) 12 is not provided at the position corresponding to the opening 25a of the tubular member 25.

In this case, the second hole portion 26 may not be provided in the lateral surface of the tubular member 25. According to such a configuration, it is possible to cut a cost required to manufacture the tubular member 25.

As described above, according to the medium-supporting device (platen 10) of the disclosure, even when a medium-supporting surface, that is, an area of the upper panel 11, is great, the medium-supporting device can be lightweight and be formed at a low cost and with high precision. Further, the medium-supporting device (platen 10) is applied to the medium-processing apparatus (as an example, the printing and cutting apparatus 1), and thereby the medium can be processed with high precision.

Further, the following characteristic operation and effects are exerted by the present embodiment.

The platen 10 of the disclosure is characterized by including the multiple tubular members 25 each having the opening 25a arranged in parallel at given intervals so that the openings 25a are directed in the same direction, and the upper panel 11 joined to the tubular members 25 so as to block the opening 25a. According to this configuration, the multiple tubular members 25 can be used as the intermediate structures joined to the upper panel 11 instead of the conventional honeycomb structure. Accordingly, the process of cutting (or forming) the thin plates formed of, for instance, an aluminum alloy in a predetermined shape and the process of stacking and stretching the thin plates while intermittently adhering the thin plates, both of which were required to form the honeycomb structure are not required. As such, it is possible to form the intermediate structures at a very low cost, and to make the platen 10 inexpensive. Further, each tubular member 25 is only formed within a given precision range, and thereby improvement in precision of the platen 10 can be easily achieved. Furthermore, as the tubular members 25 are formed using, for instance, a resin material, the platen 10 can be made lightweight.

Further, it is preferred that the lower panel 21 is provided opposite to the upper panel 11, the upper panel 11 has the first hole portions (adsorption holes) 12 passing through the outside and inside thereof, and the multiple tubular members 25 are arranged in the closed space formed between the upper panel 11 and the lower panel 21. According to this configuration, as the closed space is under a negative pressure using the air suction means 23, an effect of sucking air in a direction directed into the closed space at the adsorption holes 12 is obtained, and the medium can adsorbed to and supported on the upper panel 11.

Further, it is preferred that the upper panel 11 has the first hole portions (adsorption holes) 12 passing through the outside and inside thereof at the positions at which it blocks the openings 25a of the tubular members 25, and each of the tubular members 25 has the second hole portion 26, which passes through the interior and exterior thereof, in the lateral surface thereof. According to this configuration, as the second hole portions 26 are provided for the lateral surfaces of the respective tubular members 26, when the closed space is under a negative pressure, the interiors of the tubular members 25 can also be under a negative pressure. Accordingly, since the adsorption holes 12 can also be formed in the upper panel 11 at the positions corresponding to the openings 25a of the tubular members 25, the degree of freedom of the arrangement position of each adsorption hole 12 can be improved.

Further, the spacers 13 for arranging the multiple tubular members 25 in parallel at regular intervals are preferably provided. According to this configuration, the minimum number of multiple tubular members 25 can be arranged in parallel to the extent to which the deformation volume is allowed at the upper panel 11. Accordingly, the intermediate structures and thus the platen 10 can further be made at a low cost. Further, as the spacers 13 are provided, the parallel arrangement work of the tubular members 25 is made easy, and thus the platen 10 can be manufactured with ease and at a low cost. Furthermore, when the tubular members 25 are formed using, for instance, a resin material, the outer circumferential portions thereof are predicted to be what is called thick (that is, that the difference between the inner diameter and the outer diameter is great) compared to when they are formed using a metal material. However, in the case of such a thick structure, the solid region is increased compared to the case of a thin structure. As such, there is a problem that a possibility of the solid region blocking the adsorption holes 12 is increased. However, as described above, if the minimum number of tubular members 25 can be arranged in parallel, it is easy to avoid blocking the adsorption holes 12, and it is possible to prevent adsorption unbalance caused by the blockage of the adsorption holes 12 and to increase the medium processing precision.

Further, the second hole portion 26 of each tubular member 25 is preferably provided at a position at which it does not interfere with the lateral surface of the spacer 13. If the second hole portion 26 of the tubular member 25 interferes with the lateral surface of the spacer 13, the interior of the tubular member 25 cannot be under a negative pressure even when the closed space is under a negative pressure, and thus there occurs a problem that no adsorption force is generated at the adsorption hole 12 located inside the opening 25a of the tubular member 25. In contrast, according to the above configuration, since the second hole portion 26 and the lateral surface of the spacer 13 do not interfere with each other, such a problem can be prevented. Further, when the parallel arrangement work of the tubular members 25 is done, it is unnecessary to adjust the directions of the tubular members 25 such that the second hole portions 26 are not blocked by the lateral surfaces of the spacers 13. As such, the parallel arrangement work is made easy, and the platen 10 can be manufactured with ease and at a low cost.

The printing and cutting apparatus 1 of the disclosure is characterized by including the platen 10 and the air suction means 23 for sucking the air in the closed space. According to this configuration, by applying the platen 10 that is lightweight and can be formed at a low cost and with high precision, the medium can be processed with high precision, and the printing and cutting apparatus can be realized with light weight at a low cost. Particularly, the printing and cutting apparatus is preferably applied to a large flatbed type apparatus.

It is apparent that the present invention is not limited to the embodiment described above, but it can be modified in various ways without departing from the present invention. Especially, the printing and cutting apparatus has been described as an example of the medium-processing apparatus equipped with the medium-supporting device (platen), but it is not limited thereto. The medium-processing apparatus equipped with the medium-supporting device can also be applied to a printing apparatus for performing only printing on a medium, a cutting apparatus for performing only cutting on a medium or an apparatus for performing machining on a medium, an apparatus for performing ruling, and other medium-processing apparatuses.

1. A medium-supporting device comprising:
a plurality of tubular members arranged in parallel at given intervals such that a plurality of openings thereof are directed in a same direction; and
a first plate-like member joined to the plurality of tubular members so as to block the plurality of openings.

2. The medium-supporting device according to claim 1, further comprising:
a second plate-like member provided opposite to the first plate-like member, wherein
the first plate-like member has a plurality of first hole portions passing through an outside and an inside thereof, and
the plurality of tubular members are arranged in a closed space formed between the first plate-like member and the second plate-like member.

3. The medium-supporting device according to claim 2, wherein
the first plate-like member has the plurality of first hole portions passing through the outside and the inside thereof at positions at which the first plate-like member blocks the plurality of openings of the plurality of tubular members, and
each of the plurality of tubular members has a second hole portion, which passes through an interior and an exterior thereof, on a lateral surface thereof.

4. The medium-supporting device according to claim 1, further comprising:
a spacer configured to arrange the plurality of tubular members in parallel at regular intervals.

5. The medium-supporting device according to claim 3, wherein
the second hole portions of the tubular members are provided at positions at which the second hole portions do not interfere with a lateral surface of the spacer.

6. (canceled)

7. The medium-supporting device according to claim 4, wherein
the second hole portions of the tubular members are provided at positions at which the second hole portions do not interfere with a lateral surface of the spacer.

8. A medium-processing apparatus comprising the medium-supporting device according to claim 1, and an air suction means for sucking air in the closed space.

9. A medium-processing apparatus comprising the medium-supporting device according to claim 2, and an air suction means for sucking air in the closed space.

10. A medium-processing apparatus comprising the medium-supporting device according to claim 3, and an air suction means for sucking air in the closed space.

11. A medium-processing apparatus comprising the medium-supporting device according to claim 4, and an air suction means for sucking air in the closed space.

12. A medium-processing apparatus comprising the medium-supporting device according to claim 5, and an air suction means for sucking air in the closed space.

13. A medium-processing apparatus comprising the medium-supporting device according to claim 7, and an air suction means for sucking air in the closed space.
